(19) United States
(12) Patent Application Publication
(10) Pub. No.: US 2015/0002037 A1
(43) Pub. Date: Jan. 1, 2015

(54) LIGHT EMITTING DIODE DRIVING APPARATUS

(71) Applicant: SAMSUNG ELECTRO-MECHANICS CO., LTD., Suwon (KR)

(72) Inventors: Sang Hyun CHA, Suwon (KR); Deuk Hee PARK, Suwon (KR); Chan Woo PARK, Suwon (KR); Yun Joong LEE, Suwon (KR); Jong Tae HWANG, Suwon (KR); Je Hyeon YU, Suwon (KR); Soo Hyun MOON, Suwon (KR); Hye Jin LEE, Suwon (KR); Chang Seok LEE, Suwon (KR)

(73) Assignee: SAMSUNG ELECTRO-MECHANICS CO., LTD., Suwon (KR)

(21) Appl. No.: 14/027,491

(22) Filed: Sep. 16, 2013

(30) Foreign Application Priority Data
Jun. 28, 2013 (KR) 10-2013-0075749

(51) Int. Cl. H05B 33/08

(52) U.S. Cl. CPC H05B 33/0815
USPC 315/200 R

(57) ABSTRACT

There is provided a light emitting diode driving apparatus charging and discharging a valley fill power by comparing a voltage level of rectified power with a preset reference voltage. The light emitting diode driving apparatus includes a rectifying unit rectifying input AC power, a charging and discharging unit comparing a voltage level of power rectified by the rectifying unit with a preset reference voltage to charge and discharge the rectified power depending on the comparison result, and a driving unit driving a light emitting diode depending on the power rectified by the rectifying unit and a voltage discharged from the charging and discharging unit.

### CROSS-REFERENCE TO RELATED APPLICATIONS

This application claims the priority of Korean Patent Application No. 10-2013-0075749 filed on Jun. 28, 2013, in the Korean Intellectual Property Office, the disclosure of which is incorporated herein by reference.

### BACKGROUND OF THE INVENTION

1. Field of the Invention

The present invention relates to a light emitting diode driving apparatus adopting a valley fill circuit.

2. Description of the Related Art

Alight emitting diode (LED) is a semiconductor device formed to have a p-n junction structure and emit light by the recombination of electrons and holes and has been applied to various fields with the recent development of semiconductor technology.

In particular, the LED has high efficiency, a relatively long lifespan and is eco-friendly and the fields of application thereof are continuously being expanded, as compared to those of existing light emitting apparatuses.

In general, the LED has a structure which may be driven by having several volts of direct current (DC) power applied thereto. Therefore, the LED requires separate components so as to be driven with commercially-available alternating current (AC) power used in domestically, commercially or the like.

To drive the LED with commercially-available AC power, the LED driving apparatus generally includes a rectifier circuit, an AC-DC converter, and the like.

When the LED driving apparatus uses the DC power supply, a circuit for supplying AC power may be relatively complicated.

Therefore, a method for directly driving the LED with power obtained by rectifying the AC power has been proposed. However, a voltage level of the rectified power varies in a sine wave form from a voltage of 0 to a maximum voltage and the voltage level of the power rectified depending on the varying voltage may be reduced to a minimum voltage for driving a group of LEDs or below, thereby causing a flicker phenomenon in which light flickers.

To solve such a problem, the LED driving apparatus adopting the valley fill circuit as disclosed in the following related art has been proposed, but the valley fill circuit has a limitation on the capacity of a capacitor used to charge an input power supply and the use time, thereby causing a problem of increasing the circuit area and manufacturing costs of the LED driving apparatus and reducing the lifespan of the LED driving apparatus.

### RELATED ART DOCUMENT

Korean Patent Laid-Open Publication No. 10-2012-0043188

### SUMMARY OF THE INVENTION

An aspect of the present invention provides a light emitting diode driving apparatus charging and discharging valley fill power by comparing a voltage level of rectified power with a preset reference voltage.

According to an aspect of the present invention, there is provided a light emitting diode driving apparatus, including: a rectifying unit rectifying input alternating current (AC) power; a charging and discharging unit comparing a voltage level of power rectified by the rectifying unit with a preset reference voltage to charge and discharge the rectified power depending on the comparison result; and a driving unit driving a light emitting diode depending on the power rectified by the rectifying unit and a voltage discharged from the charging and discharging unit.

The charging and discharging unit may charge the rectified power when the voltage level of the rectified power is higher than the reference voltage and may discharge the charged power when the voltage level of the rectified power is lower than the reference voltage.

The charging and discharging unit may include: a switch charging and discharging the rectified power; a capacitor charging and discharging the rectified power depending on a charging and discharging switching of the switch; and a setting unit setting the reference voltage to drive the switch depending on the comparison result.

The charging and discharging unit may further include a limiting unit limiting a rush current input to the switch.

The charging and discharging unit may further include a balance unit connected between a gate of the switch and a cathode of a light emitting diode of a final terminal connected to the driving unit to control current symmetry of the rectified power input to the light emitting diode.

The charging and discharging unit may further include a zener diode for protection connected between the gate and a source of the switch to protect the switch.

The setting unit may include the zener diode connected between the gate of the switch and a ground and the charging and discharging unit may stop charging when the voltage level of the rectified power is equal to or greater than a sum of a reverse breakdown voltage of the zener diode and a forward voltage of the zener diode for protection.

The setting unit may further include a resistor connected between the gate of the switch and a power output terminal of the rectifying unit or between the gate of the switch and the cathode of the light emitting diode of the final terminal of the light emitting diode array driven by the driving unit.

The reference voltage may be equal to or greater than a light emitting diode minimum driving voltage.

According to an aspect of the present invention, there is provided a light emitting diode driving apparatus, including: a rectifying unit rectifying input AC power; a charging and discharging unit charging power rectified by the rectifying unit and discharging the charged power during the period when a voltage level of the rectified power is lower than a preset reference voltage; and a driving unit driving a light emitting diode depending on the power rectified by the rectifying unit and a voltage discharged from the charging and discharging unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram schematically illustrating a light emitting diode driving apparatus according to an embodiment of the present invention;

FIG. 2 is a graph illustrating electrical characteristics of the light emitting diode driving apparatus according to the embodiment of the present invention illustrated in FIG. 1;

FIG. 3 is a circuit diagram schematically illustrating a light emitting diode driving apparatus according to another embodiment of the present invention;

FIG. 4 is a graph illustrating electrical characteristics of the light emitting diode driving apparatus according to another embodiment of the present invention illustrated in FIG. 3;

FIG. 5 is a circuit diagram schematically illustrating a light emitting diode driving apparatus according to another embodiment of the present invention; and

FIG. 6 is a graph illustrating electrical characteristics of the light emitting diode driving apparatus according to another embodiment of the present invention illustrated in FIG. 5.

### DETAILED DESCRIPTION OF THE EMBODIMENTS

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

Embodiments of the present invention will now be described in detail with reference to the accompanying drawings.

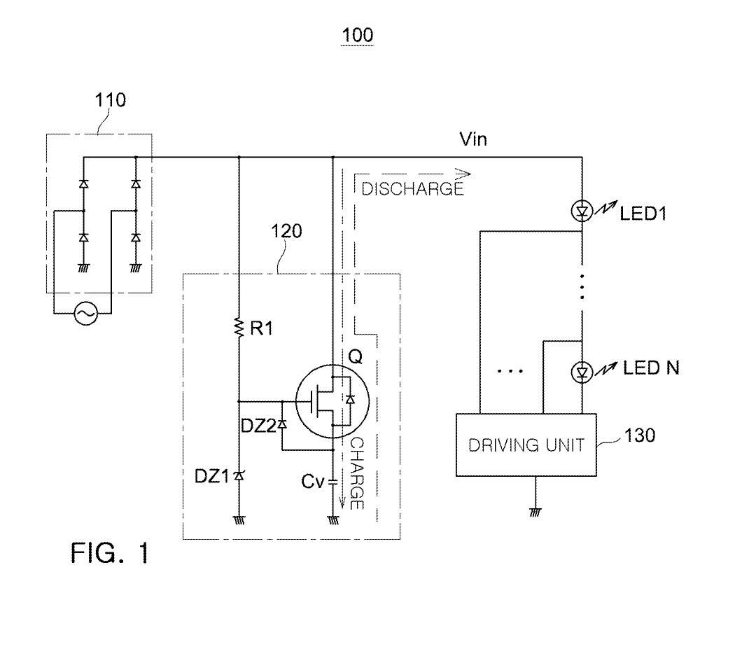

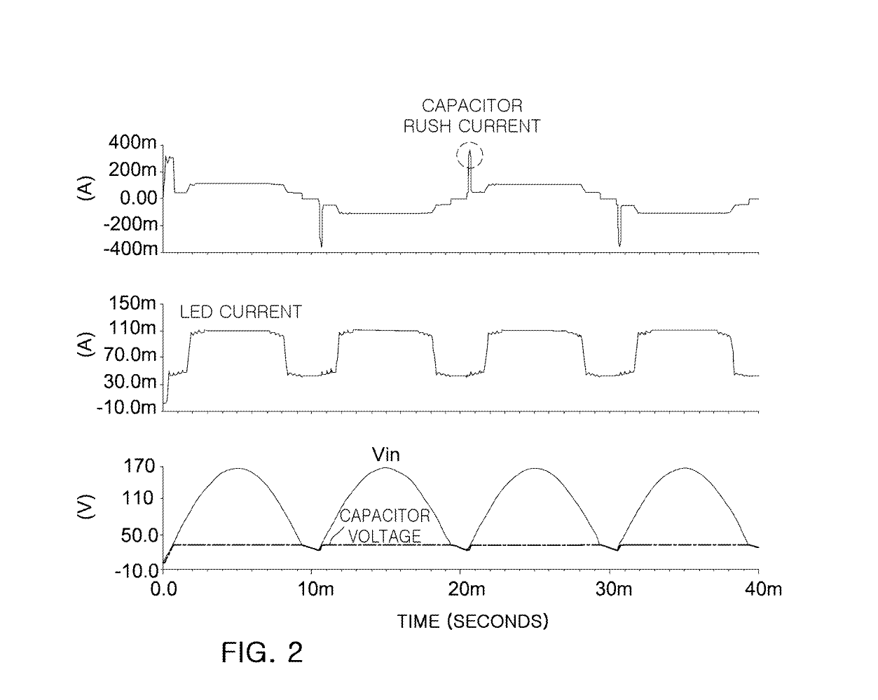

FIG. 1 is a circuit diagram schematically illustrating a light emitting diode driving apparatus according to an embodiment of the present invention and FIG. 2 is a graph illustrating electrical characteristics of the light emitting diode driving apparatus according to the embodiment of the present invention illustrated in FIG. 1.

Referring to FIG. 1, a light emitting diode (LED) driving apparatus 100 according to an embodiment of the present invention may include a rectifying unit 110, a charging and discharging unit 120, and a driving unit 130.

The rectifying unit 110 may rectify input AC power to be supplied to light emitting diodes LED1 to LEDN array.

The driving unit 130 may drive LEDs of the corresponding light emitting diodes LED1 to LEDN array depending on a voltage level of power rectified by the rectifying unit 110.

In connection therewith, describing in more detail, the light emitting diodes LED1 to LEDN array may include at least one light emitting diode, the plurality of light emitting diodes of a first light emitting diode LED1 to an N-th light emitting diode LEDN may also be connected to each other in series, and the voltage which may be driven by the connection of respective light emitting diodes may vary.

That is, the first light emitting diode LED1, the first and second light emitting diodes (LED1 and not illustrated), the first to third light emitting diodes (LED1 and not illustrated), and the like, have different driving voltages, the required driving voltage thereof may be increasingly high, and the driving voltage required to drive the first to N-th light emitting diodes LED1 to LEDN may be highest.

The voltage level of the power rectified by the rectifying unit 110 may vary in a sine wave form from the voltage of ‘0’ to the maximum voltage, when the voltage of the rectified power is relatively low, the first light emitting diode LED1, the first and second light emitting diodes (LED1 and not illustrated), the first to third light emitting diodes (LED1 and not illustrated), and finally, the first to N-th light emitting diodes LED1 to LEDN are sequentially driven, and then, in a reverse order, the first to N-th light emitting diodes LED1 to LEDN, the first to third light emitting diodes (LED1 and not illustrated), the first and second light emitting diodes (LED1 and not illustrated), and finally, the first light emitting diode LED1 may be driven.

In this case, the voltage level of the rectified power may vary in a sine wave form from the voltage of ‘0’ to the maximum voltage, such that the voltage level of the power rectified at the LED minimum driving voltage for driving the LED or below which drives the first light emitting diode LED1 may be low, and a period in which the overall light emitting diodes LED1 to LEDN array is not operated occurs, such that a flicker phenomenon in which light of 120 Hz flickers when the input AC power of 60 Hz is rectified may occur.

To solve this problem, the valley fill circuit charging and discharging the rectified power may be adopted, but the circuit area and manufacturing costs of the light emitting diode driving apparatus may increase and the lifespan of the light emitting diode may be reduced, due to capacity of a capacitor for charging and discharging the rectified power, a size depending on the capacity, and use time of the capacitor.

To solve such a problem, the light emitting diode driving apparatus 100 according to the embodiment of the present invention may include a charging and discharging unit 120.

When the voltage level of the rectified power is higher than a preset reference voltage, the charging and discharging unit 120 may charge the rectified power, and when the voltage level of the rectified power is lower than the preset reference voltage, the charged power may be discharged to be supplied to the light emitting diodes LED1 to LEDN array. Herein, the reference voltage may be the minimum driving voltage or more, which is required to drive the LED. Further, the voltage level of the rectified power may vary in a sine wave form from the voltage of ‘0’ to the maximum voltage, and therefore, the charging and discharging unit 120 may only discharge the charged power during the period when the voltage level of the rectified power is lower than the preset reference voltage, and may charge the rectified power for at least a portion of time other than the time when the voltage level of the rectified power is lower than the preset reference voltage.

To perform the above-mentioned charging and discharging operation, the charging and discharging unit 120 may include a switch Q, a capacitor Cv, and setting units R1 and DZ1.

The switch Q performs a switching operation to be able to provide a charging path of the rectified power and a discharging path of the charged power.

The capacitor Cv may charge the rectified power and discharge the charged power along a power transfer path formed by the switching of the switch Q.

The setting units R1 and DZ1 may include a resistor R1 and a zener diode DZ1, in which the resistor R1 may be connected between a gate of the switch Q and a power output terminal of the rectifying unit 110 and the zener diode DZ1 may be connected between the gate of the switch Q and a ground.

The so-configured setting units R1 and DZ1 may provide the voltage required for driving to the gate of the switch Q and may also set the reference voltage. That is, when a rectified power Vin is higher than a setting voltage of the zener diode DZ1, the switch Q is turned on and thus the power may be charged in the capacitor Cv. Thereafter, when the voltage level of the power charged in the capacitor Cv is equal to or greater than a sum of a reverse breakdown voltage of the zener diode DZ1 and a forward voltage of a zener diode DZ2 adopted for protection, the charging of the power of the capacitor Cv may stop.

Then, when the voltage level of the rectified power Vin is lower than the setting voltage of the zener diode DZ1, charges of the capacitor Cv may be discharged to be supplied to the light emitting diodes LED1 to LEDN array through a body diode of the switch Q.

Meanwhile, when the voltage level of the rectified power Vin is lower than the setting voltage of the zener diode DZ1, capacitance of the capacitor Cv may be as follows.

First, the voltage variation of the rectified power Vin may be represented by the following Equation 1.

V sup·sin(φ) Equation 1

Hereinafter, an angle to make the rectified power Vin equal to the LED minimum driving voltage may depend on the following Equation 2.

$$V sup \cdot sin ( φ ) = VF 1 \\ φ = {sin}^{- 1} ( \frac{VF 1}{V sup} ) \qquad Equation 2$$

The time DT during which the voltage level of the rectified power Vin is lower than the LED minimum driving voltage, from the above-mentioned Equations, may depend on the following Equation 3.

$$V sup \cdot sin ( φ ) = VF 1 \\ DT = \frac{1}{π f} \cdot {sin}^{- 1} ( \frac{VF 1}{V sup} ) \qquad Equation 3$$

When a current flowing in the light emitting diode array for the above-mentioned time DT is called ILED, the amount of charges to be discharged by the capacitor Cv during the period DT may depend on the following Equation 4.

$$Q = ILED \cdot DT = \frac{ILED}{π f} \cdot {sin}^{- 1} ( \frac{VF 1}{V sup} ) \qquad Equation 4$$

Therefore, it can be appreciated that the minimum capacitance of the capacitor Cv needs to satisfy the following Equation 5.

$$C = \frac{Q}{VLED} = \frac{ILED \cdot DT}{VLED} = \frac{ILED}{π f \cdot VLED} \cdot {sin}^{- 1} ( \frac{VF 1}{V sup} ) \qquad Equation 5$$

For example, when the maximum voltage of the rectified power is 150V and the current ILED flowing in the light emitting diode array for the above-mentioned time DT is 40 mA, the minimum capacitance of the capacitor Cv may be 1.4 μF, such that the necessary valley fill power may be provided without adopting the capacitor having the relatively high-capacity, high-voltage performance and the lifespan of products may not be limited by not adopting the electrolytic capacitor.

Referring to FIG. 2, in the LED driving apparatus according to the embodiment of the present invention, the LED current flowing in the LED array is not reduced to ‘0’, and thus the flicker phenomenon may be considered as being removed. In this case, the capacity of the capacitor is implemented as 5 μF and is implemented by MLCC having a very small size, thereby reducing the circuit area and the manufacturing costs.

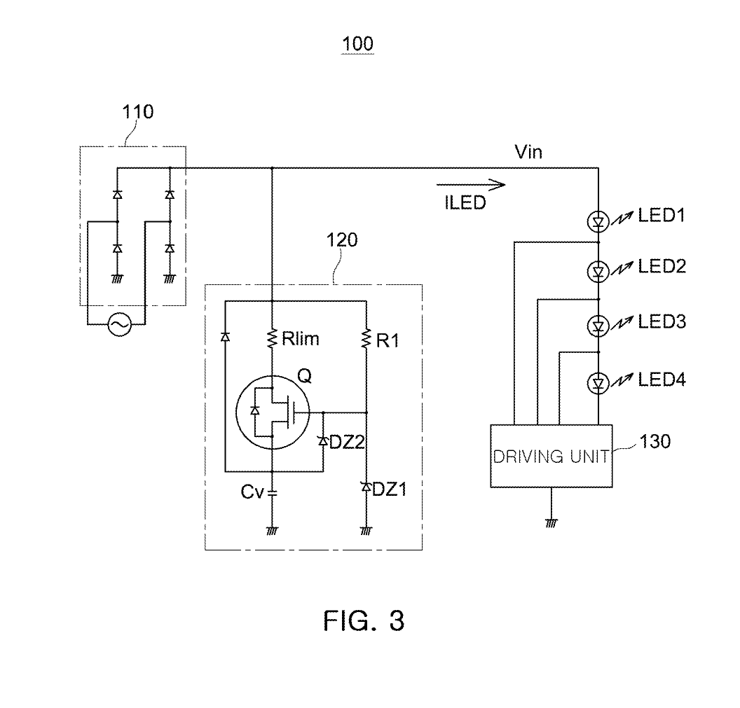

On the other hand, a peak of current charged in the capacitor may slightly increase, and in order to reduce the peak of current, as illustrated in FIG. 3, a light emitting diode driving apparatus according to another embodiment of the present invention may be proposed.

FIG. 3 is a circuit diagram schematically illustrating a light emitting diode driving apparatus according to another embodiment of the present invention.

Referring to FIG. 3, according to the light emitting diode driving apparatus 100 according to another embodiment of the present invention, the charging and discharging unit 120 may include a limiting unit, in which the limiting unit may include a resistor Rlim and the resistor Rlim may be connected between the power output terminal of the rectifying unit 110 and a drain of the switch Q to limit a rush current introduced into the switch Q (other components of the charging and discharging unit 120, the rectifying unit 110, and the driving unit 130 are the same as the description of FIG. 1, and therefore the description thereof will be omitted).

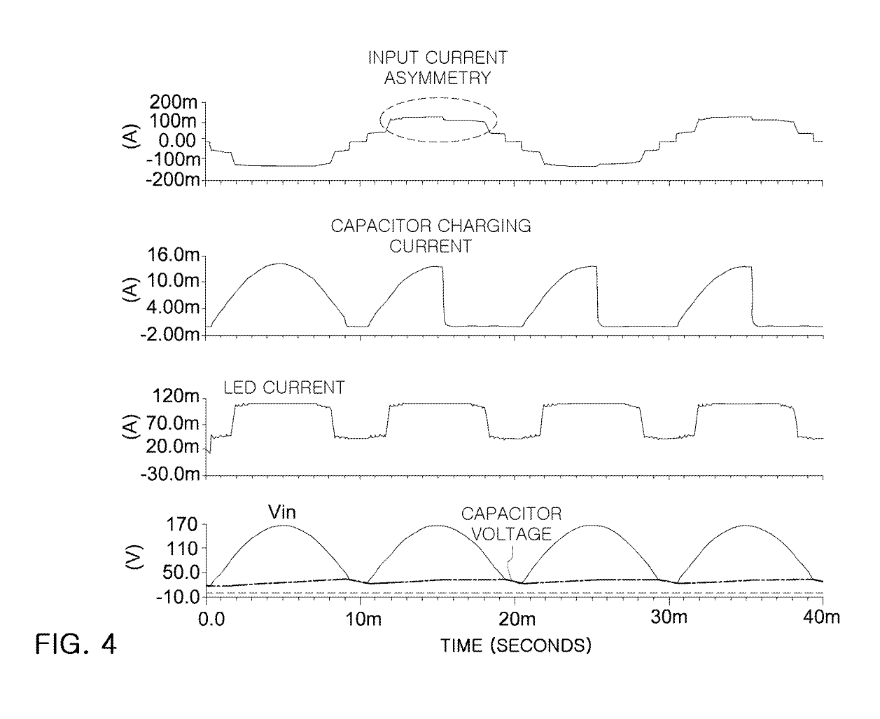

FIG. 4 is a graph illustrating electrical characteristics of the light emitting diode driving apparatus according to another embodiment of the present invention illustrated in FIG. 3.

FIG. 4 illustrates that the current peak of the input power Vin is reduced. As a result, a total harmonic distortion (THD) of the input power Vin and an electromagnetic interference (EMI) may be reduced, and thus a power factor may be improved.

However, when the voltage level of the input power Vin increases, a current is supplied, and thus a form of current may have asymmetry.

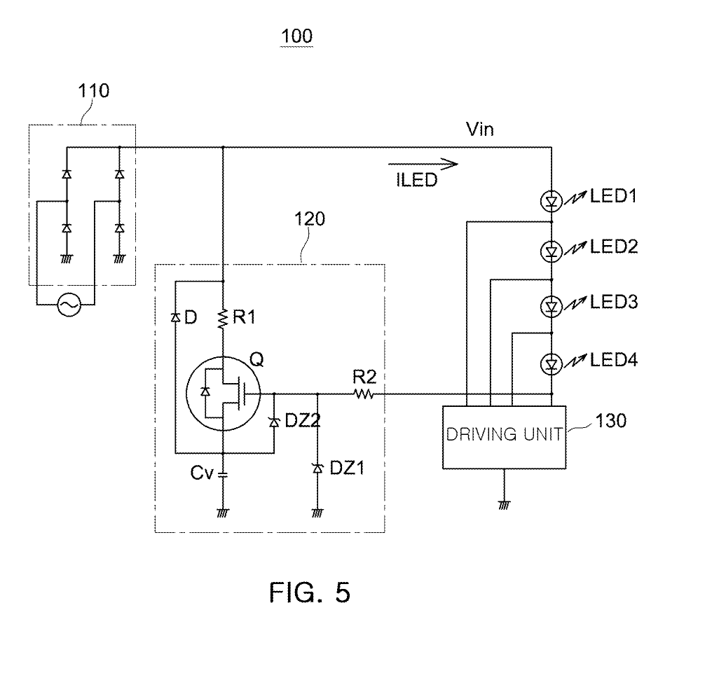

To solve the problem as described above, a light emitting diode driving apparatus according to another embodiment of the present invention as illustrated in FIG. 5 may be proposed.

FIG. 5 is a circuit diagram schematically illustrating a light emitting diode driving apparatus according to another embodiment of the present invention.

Referring to FIG. 5, according to the light emitting diode driving apparatus 100 according to another embodiment of the present invention, the setting unit R1 and DZ1 of the charging and discharging unit 120 may include a resistor R1 connected between the gate of the switch Q and a cathode of the light emitting diode LEDN of a final terminal of the light emitting diode array driven by the driving unit 130. In this case, the switch Q is driven under the voltage condition that all of the first to N-th light emitting diodes LED1 to LEDN are turned on, such that the capacitor Cv may charge power at the voltage which turns on all of the first to N-th light emitting diodes LED1 to LEDN. As a result, the capacitor Cv is charged with power at the point at which the voltage of the input power Vin reaches a peak, such that the symmetry of the current of the input power Vin may be improved.

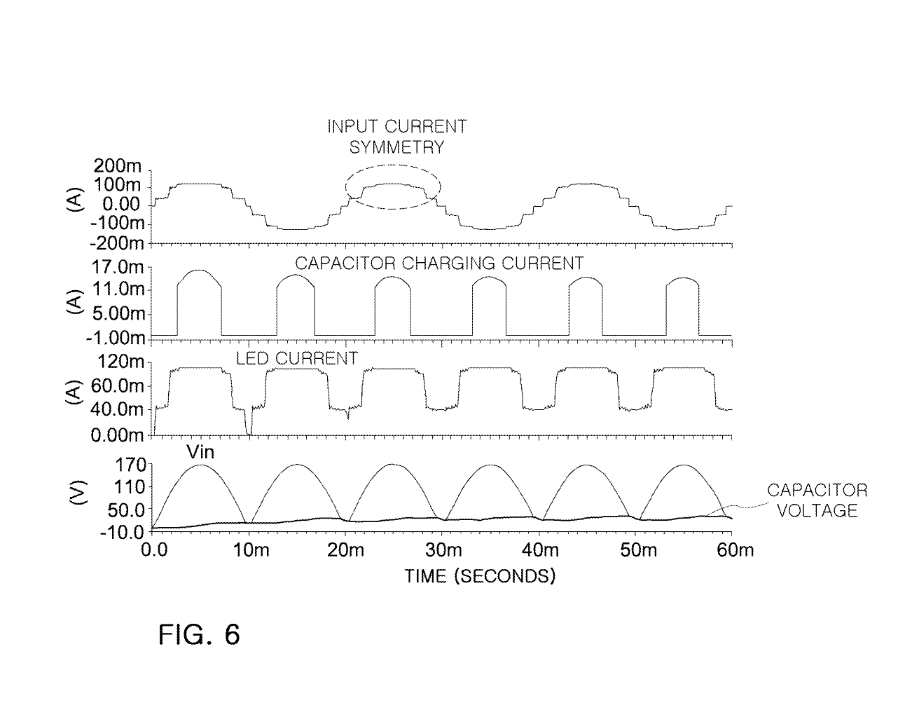

FIG. 6 is a graph illustrating electrical characteristics of the light emitting diode driving apparatus according to another embodiment of the present invention illustrated in FIG. 5.

FIG. 6 illustrates that the symmetry of the current of the input power Vin may be improved due to the connection relationship of the resistor R1 of the setting unit of the charging and discharging unit 120 illustrated in FIG. 5.

As set forth above, according to the embodiments of the present invention, the capacity of the capacitor maybe reduced by discharging the charged valley fill power only when the voltage level of the rectified power is the LED minimum driving voltage for driving the LED or below by charging and discharging the valley fill power by comparing the voltage level of the rectified power with the preset reference voltage, thereby reducing the circuit area and the manufacturing costs.

While the present invention has been shown and described in connection with the embodiments, it will be apparent to those skilled in the art that modifications and variations can be made without departing from the spirit and scope of the invention as defined by the appended claims.

What is claimed is:

1. A light emitting diode driving apparatus, comprising:
a rectifying unit rectifying input AC power;
a charging and discharging unit comparing a voltage level of power rectified by the rectifying unit with a preset reference voltage to charge and discharge the rectified power depending on the comparison result; and
a driving unit driving a light emitting diode depending on the power rectified by the rectifying unit and a voltage discharged from the charging and discharging unit.

2. The light emitting diode driving apparatus of claim 1, wherein the charging and discharging unit charges the rectified power when the voltage level of the rectified power is higher than the reference voltage and discharges the charged power when the voltage level of the rectified power is lower than the reference voltage.

3. The light emitting diode driving apparatus of claim 1, wherein the charging and discharging unit includes:
a switch charging and discharging the rectified power;
a capacitor charging and discharging the rectified power depending on a charging and discharging switching of the switch; and
a setting unit setting the reference voltage to drive the switch depending on the comparison result.

4. The light emitting diode driving apparatus of claim 3, wherein the charging and discharging unit further includes a limiting unit limiting a rush current input to the switch.

5. The light emitting diode driving apparatus of claim 3, wherein the charging and discharging unit further includes a balance unit connected between a gate of the switch and a cathode of a light emitting diode of a final terminal connected to the driving unit to control current symmetry of the rectified power input to the light emitting diode.

6. The light emitting diode driving apparatus of claim 3, wherein the charging and discharging unit further includes a zener diode for protection connected between the gate and a source of the switch to protect the switch.

7. The light emitting diode driving apparatus of claim 6, wherein the setting unit includes the zener diode connected between the gate of the switch and a ground, and
the charging and discharging unit stops charging when the voltage level of the rectified power is equal to or greater than a sum of a reverse breakdown voltage of the zener diode and a forward voltage of the zener diode for protection.

8. The light emitting diode driving apparatus of claim 7, wherein the setting unit further includes a resistor connected between the gate of the switch and a power output terminal of the rectifying unit or between the gate of the switch and the cathode of the light emitting diode of the final terminal of the light emitting diode array driven by the driving unit.

9. The light emitting diode driving apparatus of claim 1, wherein the reference voltage is equal to or greater than a light emitting diode minimum driving voltage.

10. A light emitting diode driving apparatus, comprising:
a rectifying unit rectifying input AC power;
a charging and discharging unit charging power rectified by the rectifying unit and discharging the charged power during the period in which a voltage level of the rectified power is lower than a preset reference voltage; and
a driving unit driving a light emitting diode depending on the power rectified by the rectifying unit and a voltage discharged from the charging and discharging unit.

11. The light emitting diode driving apparatus of claim 10, wherein the charging and discharging unit charges the rectified power when the voltage level of the rectified power is higher than the reference voltage and discharges the charged power when the voltage level of the rectified power is lower than the reference voltage.

12. The light emitting diode driving apparatus of claim 10, wherein the charging and discharging unit includes:
a switch charging and discharging the rectified power;
a capacitor charging and discharging the rectified power depending on a charging and discharging switching of the switch; and
a setting unit setting the reference voltage to drive the switch depending on the comparison result.

13. The light emitting diode driving apparatus of claim 12, wherein the charging and discharging unit further includes a limiting unit limiting a rush current input to the switch.

14. The light emitting diode driving apparatus of claim 12, wherein the charging and discharging unit further includes a balance unit connected between a gate of the switch and a cathode of a light emitting diode of a final terminal connected to the driving unit to control current symmetry of the rectified power input to the light emitting diode.

15. The light emitting diode driving apparatus of claim 12, wherein the charging and discharging unit further includes a zener diode for protection connected between the gate and a source of the switch to protect the switch.

16. The light emitting diode driving apparatus of claim 15, wherein the setting unit includes the zener diode connected between the gate of the switch and a ground, and
the charging and discharging unit stops charging when the voltage level of the rectified power is equal to or greater than a sum of a reverse breakdown voltage of the zener diode and a forward voltage of the zener diode for protection.

17. The light emitting diode driving apparatus of claim 16, wherein the setting unit further includes a resistor connected between the gate of the switch and a power output terminal of the rectifying unit or between the gate of the switch and the cathode of the light emitting diode of the final terminal of the light emitting diode array driven by the driving unit.

18. The light emitting diode driving apparatus of claim 10, wherein the reference voltage is equal to or greater than a light emitting diode minimum driving voltage.
